(19) United States
(12) Patent Application Publication
(10) Pub. No.: US 2016/0210108 A1
(43) Pub. Date: Jul. 21, 2016

(54) VIEW SHARING AND DUAL PERMISSION REMOTE BROWSING METHODS AND SYSTEMS

(71) Applicant: ZAG HOLDINGS INC., Toronto (CA)

(72) Inventor: Igal ROYTBLAT, Toronto (CA)

(21) Appl. No.: 14/914,343

(22) PCT Filed: Aug. 29, 2014
(86) PCT No.: PCT/CA2014/000664

§ 371 Date: Feb. 25, 2016

Related U.S. Application Data
(60) Provisional application No. 61/872,513, filed on Aug. 30, 2013.

(51) Int. Cl. G06F 3/14; G09G 5/12; G09G 5/373; G06F 3/0484

(52) U.S. Cl. CPC G06F 3/1462; G06F 3/04842; G06F 3/04845; G09G 5/12; G09G 5/373

(57) ABSTRACT

Embodiments of the present technology relate to view sharing and cooperative browsing sessions. An example method includes receiving a first view of a data representation generated by a first computing system, the first view representing content that is currently being displayed on a display device of the first computing system, and sharing the first view of the data representation with a second computing system, wherein sharing the first view includes applying a user mode to the first view to create a second view that includes at least a part of the first view, the second view being an altered version of the first view, the second view being displayed on a display device of the second computing system.

### CROSS REFERENCE TO RELATED APPLICATIONS

This application claims the priority benefit of U.S. Provisional Application Ser. No. 61/872,513, filed on Aug. 30, 2013, titled “Systems and Methods for Providing a Remote Mapping Display”, which is hereby incorporated by reference herein in its entirety, including all references cited therein.

### FIELD OF THE PRESENT TECHNOLOGY

The present technology relates generally view sharing, and more specifically, but not by way of limitation, to systems and methods that provide view sharing and in some embodiments, dual remote browsing methods where a first party can share a view of their data representation with a second party. The view of the data representation that is seen by the second party is an altered or modified version of the view seen by the first party, meaning that the view seen by the second party can contain different information that the view seen by the first party.

### SUMMARY

Embodiments of the present technology include a method, comprising: (a) receiving a first view of a data representation generated by a first computing system, the first view representing content that is currently being displayed on a display device of the first computing system; (b) sharing the first view of the data representation with a second computing system; and (c) applying a user mode to the first view to create a second view that is an altered version of the first view.

Other embodiments of the present technology include a method of a cooperative browsing session, comprising: (a) generating a first view of a first data representation provided by a first computing system that is executing an underlying application, the first data representation being displayed on a display device of the first computing system, the first view being generated by applying a first user profile or mode for a first user of the first computing system; (b) generating a second view of a second data representation, the second data representation being generated from a same underlying application as the underlying application that is executing on the first computing system, the same underlying application being executed on a second computing device, the second data representation being displayed on a display device of the second computing system, the second view being generated by applying a second user profile or mode for a second user of the second computing system; and (c) managing the second data representation of the second view by the first computing device.

Embodiments of the present technology are directed to a method executed by a computing system, the computing system comprising a processor and memory for storing executable instructions, the processor executing the instructions to perform the method, the method comprising: (a) generating a representation of an underlying application or file; (b) sharing the representation by: (i) applying a first user profile or mode to the representation to generate a first view of the representation; and (ii) applying a second user profile or mode to the representation to generate a second view of the representation, the second view being different from the first view; (c) providing the first view to a first computing system; and (d) providing the second view to a second computing system.

### BRIEF DESCRIPTION OF THE DRAWINGS

FIG. 1 is a high level schematic diagram of data representation for practicing aspects of the present technology.

FIG. 2 is a signal flow diagram of an example process for dual permission view sharing.

FIG. 3A is a first view of a data representation displayed on a first computing system.

FIG. 3B is a second view of the data representation displayed on a second computing system.

FIG. 4A is a first view of another data representation displayed on a first computing system.

FIG. 4B is a second view of the data representation of FIG. 4A, displayed on a second computing system.

FIG. 5A is a flowchart of a method for dual permission view sharing.

FIG. 5B is a flowchart of another example method for dual permission view sharing.

FIG. 6 is a flowchart of an example method of cooperative browsing.

FIG. 7 is a schematic diagram of a computing system that is used to implement embodiments according to the present technology.

### DETAILED DESCRIPTION

Generally, the present technology is directed to methods for sharing a view of data representations such as a data representation that comprises a map or three-dimensional model. The sharing occurs between two or more computing systems that are located remotely from one another. In one example, a first computing system generates a first view of a data representation. For example, the first view would be what is currently being displayed to a user of the first computing system. In one example, the current display is of a desktop of the first computing system. In another example, the current display is of a program or group of programs that are being executed on the first computing system.

In general, a data representation is a representation of what is being output to a user on a display device of a computing system. For example, if the user is viewing a three dimensional model, the data representation would include the visual representation of the model that is displayed. In greater detail, the data representation can be shared with a second data representation displayed on a second computing system by synchronizing a plurality of three dimensional model data points in both the first and second views. The data points can include six different axes (e.g., camera positions) relative to the model (data representation).

In another example, if the data representation is a map, the representation would be of the map that is being used by the user. The data representation can include multiple windows, applications, representations, or other data that is being displayed to the user. In more detail, synchronization points will comprise center coordinates of the map and zoom levels. These points will be synchronized in both the first and second views such that the first view and second view include these parameters. Additional details such as map annotations, controls, and other features can be controlled by the local underlying map application.

The present technology comprises, in some embodiments, a view sharing application, hosted on a server, that functions as an interface between the first computing system with a second (or more) computing system. The intermediate server manages the view sharing process for the first computing system and the second computing system. That is, while some embodiments will described the use of view sharing applications that reside on the computing systems of end users, the view sharing application can also reside on a server. A user profile or mode for each of the users can be applied to a current view that is displayed to the user to alter the view for the user in accordance with permissions for the user. For example, the intermediate server can apply a first profile or mode to a view for a first user. Likewise, the intermediate server can apply a second profile or mode to the same view for a second user to create a second view. The second view is an altered version of the first view.

The altering of a view can include changing, deleting, modifying, editing, adding to, resizing, repositioning, reformatting, or other similar functions that can be applied to content of a first view such that the content is made different in a second view.

In some embodiments, the intermediate server is a proxy that allows the first and second computing systems to share a view. Each of the end user computing systems will them apply a user profile or mode to the shared view. In general, each of the computing systems comprises a view sharing application or plug-in that is configured to display to the first user a first view that is an unaltered view of a data representation. The second computing device receives the first view of the data representation and creates a second view using the view sharing application. The second view comprises an altered version of the first view such that the second view is different in appearance from the first view. For example, a portion of content in the first view is not seen in the second view.

In another example, the second view includes more information that what is shown in the first view. For example, if the first view is being shown to a travel agent and the second view is being shown to a traveler, the second view can include advertisements for add on products or services. In one example, the first view includes a view of a hotel booking application. The second view includes an altered view of the hotel booking application that blocks out any proprietary pricing data. The second view also includes advertisements for rental cars or entertainment options that are provided by third parties. These advertisements can be targeted to the traveler's preferences.

The data representation is generated by an underlying application such as a travel or hotel reservation application, a mapping application, or any other application where view sharing and dual permission access is desired.

In some embodiments, the data representation is shared by the first and second computing systems, but the view that is generated for the second computing system is altered by the view sharing application executing on the second computing system. In one embodiment, view sharing application executing on the first computing system provides the first user with an unmodified view and/or unmodified controls of the underlying application.

The view sharing application that executes on the first computing system applies a first user profile or mode (if needed) that provides the first user with views and access permissions that are established for the first user. The view sharing application that executes on the second computing system applies a second user profile or mode that provides the second user with views and access permissions that are established for the second user. In one example, the first user is a travel agent. A travel agent profile or mode is applied to by the view sharing application to an underlying application (e.g., data representation), which includes a travel reservation application. The second user is a traveler. A traveler/customer profile or mode is applied by the view sharing application that executes on the second computing device. The traveler/customer profile specifies that sensitive information such as proprietary pricing, costs, or other travel agent level information is removed from the second view generated for the traveler.

The view sharing application can interface or integrate with a browser or other similar user interface that executes on a computing system. For example, an Internet browser client can be coupled with the view sharing application to provide view sharing features for an end user. Again, the view sharing features will depend upon the profile or mode that is available to the end user.

In one embodiment, sharing the first view comprises the view sharing application applying a user mode to the first view to create a second view. In one embodiment, the second view is an altered version of the first view. For example, if several windows are present in the first view, the sharing process includes the view sharing application of the second computing system removing one or more of the several windows in the second view. Thus, the user of the second computing system will see only the windows that were not removed from view by the view sharing application.

In another example, the first view can include a map application that displays a map of a geographical area. Sharing of the first view can include the view sharing application altering a first view by enlarging the map application such that the user of the second computing system will only see a portion of the map as the second view.

In some embodiments, the first user can control how the second user can use an underlying application that is being executed by the first computing system. The second user can use the shared underlying application, but with a reduced or different functionality such that the second user cannot use the same set of tools for the application that are available to the first user. These and other advantages of the present technology will be described in greater detail below with reference to the collective drawings.

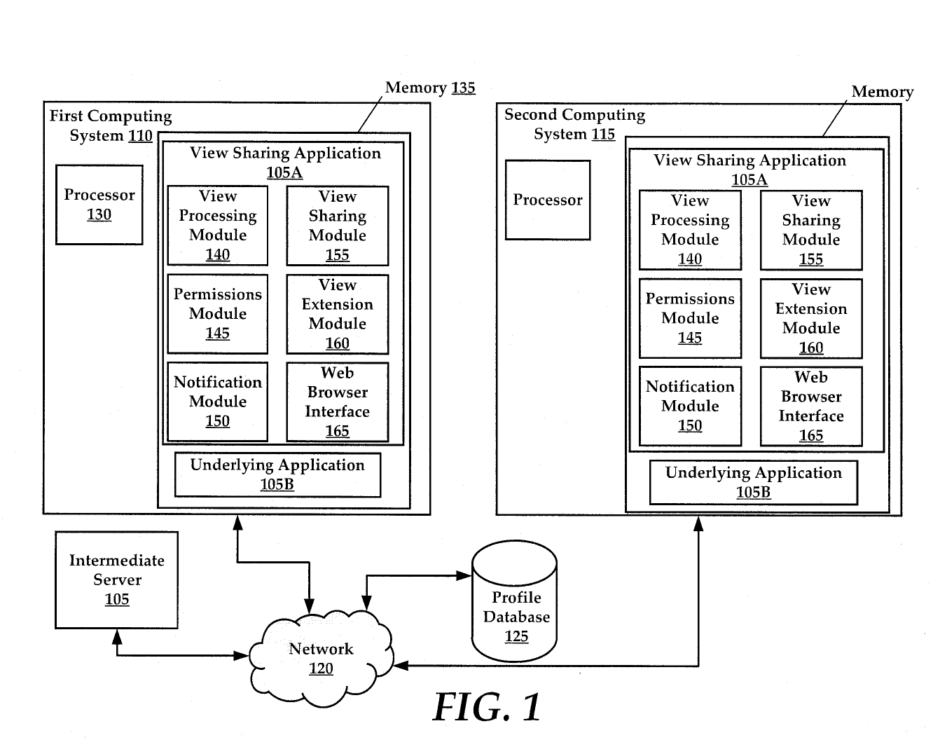

Referring to FIG. 1, a computing architecture 100 is illustrated. The computing architecture comprises, in one embodiment, an intermediate server 105, a first computing system 110, a second computing system 115, a network 120, and a profile database 125. It will be understood that the components of the computing architecture are capable of communicating with one another over the network 120. The network 120 can comprise any one or combination of private or public networks such as the Internet.

While both the first and second computing systems 110 and 115 each have a view sharing application 105A that resides in memory. A processor will execute the view sharing application 105A to generate a view of a data representation that is generated by an underlying application 105B. Again, the view sharing application 105A will apply a user profile or mode and will tailor a view for the user based on the permissions included in the user profile or mode. In some embodiments, the underlying application 105B only resides on the first computing device 110. In other embodiments, both the first computing device 110 and the second computing device 115 each comprise the underling application 105B.

While both the first and second computing systems 110 and 115 both comprise a view sharing application 105A, FIG. 1 illustrates only components for the first computing system 110 for purposes of brevity.

Generally, the first computing system 110 (as well as the second computing system) comprises a processor 130 and memory 135. The memory 135 stores the view sharing application 105A that includes modules such as a view processing module 140, a mode module 145, a notification module 150, a view sharing module 155, and a view extension module 160. These modules are merely an example configuration of the logic stored in memory 135. The functionalities of individual modules can be combined or separated out into additional modules.

As used herein, the terms “module” and/or “engine” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality.

In some embodiments, the intermediate server 105 is configured to allow the first and second computing systems 110 and 115 to share views. The intermediate server 105 functions as a sharing note on the network 120. View sharing sessions can be established using the intermediate server 105, where each of the first and second computing systems 110 and 115 can join together in a view sharing session.

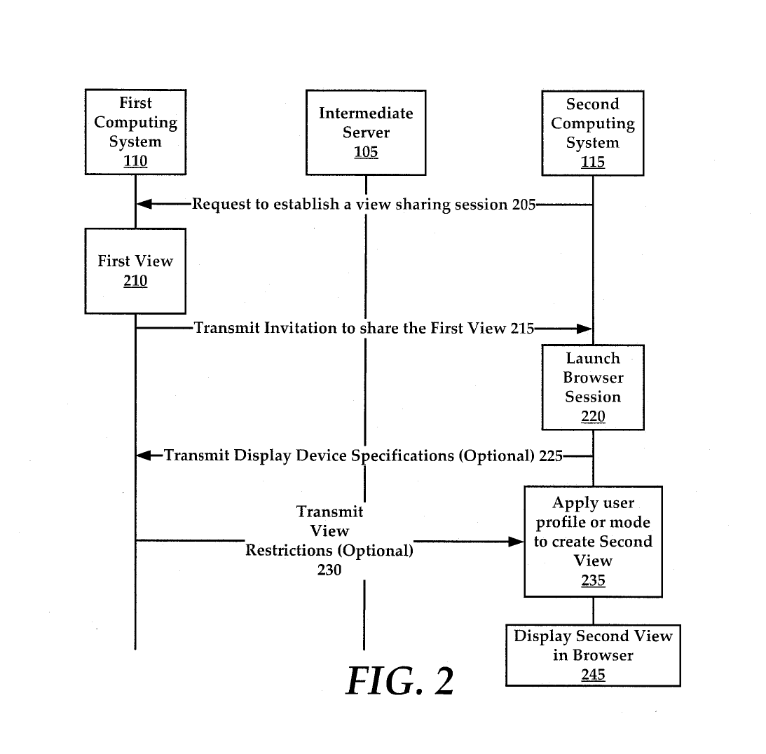

FIG. 2 is a flow diagram of a dual permission view sharing process. The second computing system 115 initiates a view sharing process by transmitting 205 to the first computing system 110 a request to establish a view sharing session. For example, the second computing system 115 can transmit an email to the first computing system 110 that includes the request. In another example, a user of the second computing system 115 can telephone the user of the first computing system 110, such as a customer service telephone call. In some instances, the request is forwarded to the first computing system 110 by the intermediate server 105.

In accordance with the present technology the process includes the view processing module 140 of the first computing system 110 establishing and displaying a first view on the first computing system 110. The first view is a current view of what is being displayed (e.g., data representation) on the first computing system 110, such as the underlying application 105B. In one example, the user of the first computing system 110 is associated with a travel agent and the first view is of an underlying application or applications such as a plurality of travel related applications such as airline booking, hotel reservations, activities, and other similar applications.

In one embodiment, the first computing system 110 transmits 215 to the second computing system 115 an invitation to share the first view 210. In this example a user of the second computing system 115 is a traveler who has solicited the help of the travel agent in booking a hotel. In one embodiment, the invitation includes an email message with a hyper link or a SMS (short message service) message with a link. The link will comprise a logical address or trigger that initiates a view sharing session on the intermediate server. In one embodiment, the view sharing session is established prior to the creation of the invitation. In another embodiment, the view sharing session is established subsequent to the creation of the invitation. That is, the view sharing session is not created until the second computing system 115 launches or clicks the link in the invitation.

When the traveler clicks on the link included in the invitation, a browser session is launched 220 on the second computing system 115. The browser application of the second computing system 115 is redirected to a location on the intermediate server 105 where the view is shared.

The launching of the browser session includes the application of a user profile or mode that determines what the second user is allowed to view, relative to the first view established for the first computing system 110. For example, the user profile will define the user as a traveler or customer. Thus, proprietary travel agency information, such as private hotel pricing, that is present in the first view, will be removed from the second view because of the permissions associated with the second user. In other embodiments, information can be added to the second view such as advertisements or other data. Thus, the alteration of the first view to create the second view can include adding to, or removing, content relative to the first view.

In some embodiments, the second computing system 115 optionally transmits 225 its display device specifications to the first computing system 110. For example, the display device specifications include user preferred screen size/resolution or manufacturer screen size/resolution information. The screen size/resolution information is used by the view sharing module 155 of the second computing system 115 in some embodiments when a view is resized or tailored for display on the second computing system 115.

In another optional process, a user of the first computing system 110 can select view restrictions that can be applied by the view sharing application 105A executing on the second computing system 115 to modify or alter portions of the first view 210. Stated otherwise, the second view is different in visual appearance from the first view due to the application of the user profile or mode for the second user.

In one embodiment, a mode for a first user and a mode for a second user are applied to the same representation generated by the underlying application 105B. This application of the different modes to the representation generated by the underlying application 105B will create the first and second views.

The process includes the view sharing application 105A of the second computing system 115 applying view restrictions (e.g., user profile or mode) to create a second view 235. The view restrictions can include view restrictions chosen by the user of the first computing system 110. These restrictions can be incorporated into the user profile or mode that is applied for the second user. In one embodiment, the view restrictions can include the travel agent specifying which of a plurality of windows will be available in the second view. In another example, the travel agent can select information that is available in the first view 210, which will be unavailable in the second view. The travel agent can view not only hotels with reservations in a hotel reservation application, but proprietary pricing for the hotels. The travel agent can select view restrictions that allow the traveler to see the same hotel reservation application and selected hotels, but the proprietary pricing values are removed.

In general, the first view 210 is a view of what is currently being displayed on the first computing system 110, such as the underlying application 105B. The second view 235 is a modified version of the first view 210 where at least a part of the first view is viewable to the traveler. This is also a view of the underlying application 105B, but with a user profile or mode for a second user that is applied by the view sharing application 105A that is executing on the second computing system 115.

In some embodiments, the travel agent and the traveler are engaged in a telephonic communications session during the view sharing session. In one embodiment, the intermediate server 105 provides VoIP (voice over Internet protocol) call session features that allow the users of the first and second computing systems to talk with one another using the network 125, rather than establishing a call independently from the view sharing session.

The process includes the intermediate server 105 transmitting 240 the first view to the second computing system 115. The view sharing application 105A executing on the second computing system 115 then modifies or alters the first view to create a second view by applying a user profile or mode to the first view to create the second view 235, and displays 245 the second view 235 in the browser application by applying a user mode for the second user to the first view.

While the above example contemplates the second view 235 being displayed in a browser application of the second computing system 115, the second view can alternatively be displayed in a web browser interface 165 intermediate server 105.

Also, in some embodiments, the intermediate server 105 can execute the step of applying a user profile or mode to the first view to create the second view 235, rather than the view sharing application 105A executing on the second computing system 115.

The terms “dual permission” refer to the process whereby the view sharing application 105A on the first computing system 110 applies one set of permissions (e.g., user profile or mode) to the first view for the user of the first computing system that govern what is provided to the user in the first view. In one embodiment, no profile or mode for the first user is needed, although the first view will be different from the second view that is ultimately generated for display. The view sharing application 105A on the second computing system 115 applies a second set of permissions (e.g., user profile or mode) to the second view for the user of the second computing system that govern what is included in the second view.

In one embodiment, the first view of the first computing system is not altered in any manner by the view sharing application 105A on the first computing system 110. The second view of the second computing system is a restricted, modified, or altered version of the first view as created by the view sharing application 105A on the second computing system 115. Again, the second view can include additional content as compared with the first view.

Referring back to FIG. 1, after a request to establish view sharing session has been received and a view sharing session is initiated, the view sharing application 105A on the first computing system 110 executes the view processing module 140 to evaluate the first view generated by the first computing system 110.

Prior to sharing the first view, the notification module 150 of the first computing system 110 can be executed to inform both of the users of the first and second computing systems that a view sharing session is being requested or that a view sharing session has been established. In one embodiment, the notification module 150 of the view sharing application 105A on the first computing system 110 will transmit to the user of the second computing system 115 a message that includes a request or an invitation to the view sharing session. As mentioned above, the invitation is a message that includes a link. When the user clicks on the link a browser session is opened. The browser directs the user to the view sharing session, which comprises the second view.

The view processing module 140 of the first computing system 110 will evaluate the first view to determine what is currently being viewed by the user of the first computing system 110. For example, the view processing module 140 of the first computing system 110 can determine what programs (e.g., underlying application(s) 105B) are being executed and displayed on the first computing system 110.

The mode module 145 of the first computing system 110 applies a user profile or mode in some embodiments, which may alter the view that is seen by the first user. For example, if the first user is a low level travel agent, the view that is seen by the agent may be slightly different from what is provided to a management level travel agent. Again, this difference in view creation is a function of the user profile or mode that is applied to the underlying application 105B.

Next, the first view is shared with the second computing system 115.

The view sharing application 105A on the second computing system 115 will apply permissions (e.g., user profile or mode for the second user) to the first view to generate the second view using the mode module 145 of the second computing system 115. In some embodiments, the user profile or mode is applied by the mode module 145. The mode module 145 can also apply user preferences (such as hotel preferences, flight time preferences, or other similar traveler preferences) or other demographic information. In another example, the restrictions can include corporate policies. For example, preferences or restrictions of an employer can be applied to the first view. The preferences or restrictions can include permissions created by the user of the second computing system. For example, a travel agent may specify that the traveler is not able to view portions of the first view, an application, or the travel agent can restrict application functionalities that are available to the traveler. In one embodiment, the travel agent can specify that the traveler can only use map resizing features of a map.

Using the first view and any permissions or restrictions obtained for the user of the second computing system 115, the view sharing application 105A of the second computing system 115 applies the permissions or restrictions to the first view to generate the second view. In one embodiment, the view sharing application 105A of the second computing system 115 alters a part of the first view to create the second view.

In one embodiment, applying a user mode to the first view comprises altering at least a part of the first view by resizing a portion of the first view to fill the second view so as to not display at least a part of the first view. For example, if the first view is a map application that is displaying a map of hotels, the second view is a rescaled version of the map that is resized to include only a portion of the hotels that are included in the first view.

In another embodiment, the view sharing application 105A of the second computing system 115 resizes non-obscured portion in such a way that the at least a part of the first view is optimally displayed on a display device of the second computing system. For example, if display device specifications for the second computing system 115 are known, the view sharing application 105A of the second computing system 115 will cause a portion of a map to be displayed at a size and/or resolution that is optimized for the second computing system 115. In one embodiment, the second computing system 115 is a mobile computing system with limited sized display screen. The map is optimized for the small size of the mobile device display screen.

Optimally displaying at least a part of the first view may also include reducing or increasing icon sizes, reconfiguring the placement of application tools such as buttons, lists, input boxes, and so forth.

In some embodiments, the shared view is of a data representation that is being generated by the underlying application 105B that is executing on the first computing system 110. The application can include controls that allow users to interact with the underlying application 105B. By way of example, if the underlying application 105B is a hotel reservation application that includes a mapping feature, the controls can include map controls that allow users to utilize the map. Controls include, but are not limited to, center map, zoom level, map type (e.g., road, satellite, hybrid, terrain, etc.), POI (point of interest) selection, view style (e.g., bird's eye, street, etc.). Other controls include mouse or pointer location control, window resizing, position or location change, POI information, map object selection, and so forth.

In one embodiment, the data representation generated by the first computing system 110 includes an application with controls, and a user of the second computing system 115 can control the application with the controls using the second computing system 115.

According to some embodiments, all or part of the controls are accessible to a user of the first computing system 110 but a portion of the controls are inaccessible to the user of the second computing system 115. For example, one user, such as a travel agent, can use all control features of the hotel reservation application, while a second user, such as a traveler, can use only a subset of the control features that are available to the travel agent. In one embodiment, the travel agent can utilize all map actions such as centering, zoom change, and map type change, as well as filter actions that allow the travel agent to apply filters to the map. For example, a filter can include restrictions of types of hotels that are displayed on the map, such as displaying only hotels that fit within a price range, a quality level, or a neighborhood. The travel agent can also utilize screen actions, and item list view actions such as position change, visibility, POI information, tab selection, image viewing, view style, and so forth.

The view sharing application 105A of the second computing system 115 is configured to receive selections from the user of the first computing system 110 as to which of the controls is accessible to the user of the second computing system 115. For example, the travel agent can select any of the available map functions listed above for use by the traveler. In one embodiment, the travel agent selects controls of mouse location change and window resize for the second user of the second computing system 115. The mouse location change feature allows the user of the second computing system 115 to control the mouse cursor of the first computing system 110 so as to highlight or point to a location on a map. As the travel agent and traveler discuss the hotel options available to the traveler, the traveler can control the location of the mouse pointer of the first computing system 110 to direct the travel agent to a particular location on the map. The window resize feature allows the user of the second computing system 115 to resize the window that the map is displayed within.

Thus, in some embodiments, the first view is a full functionality map, wherein the second view is a limited functionality map. In one embodiment, the limited functionality map comprises a set of points of interest (POIs) that have been filtered using at least one of a user profile for a user of the second computing system, corporate policies, and permissions for the user of the second computing system, or combinations thereof. These types of filtering information can be stored in the profile database 125.

For example, the user profile may include preferences of the traveler. Hotels are located for the traveler that correspond to their preferences. Only these corresponding or preferred hotels are displayed on the map. In another example, the traveler will only see hotels that are allowed in view of corporate policies such as price restraints or location restraints.

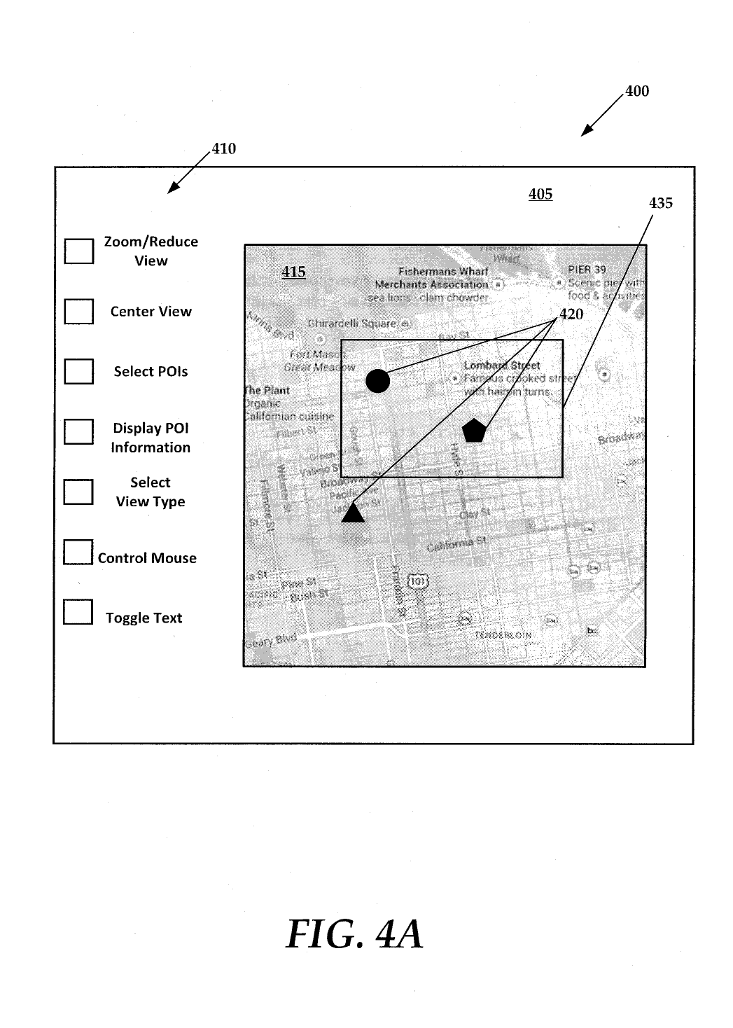

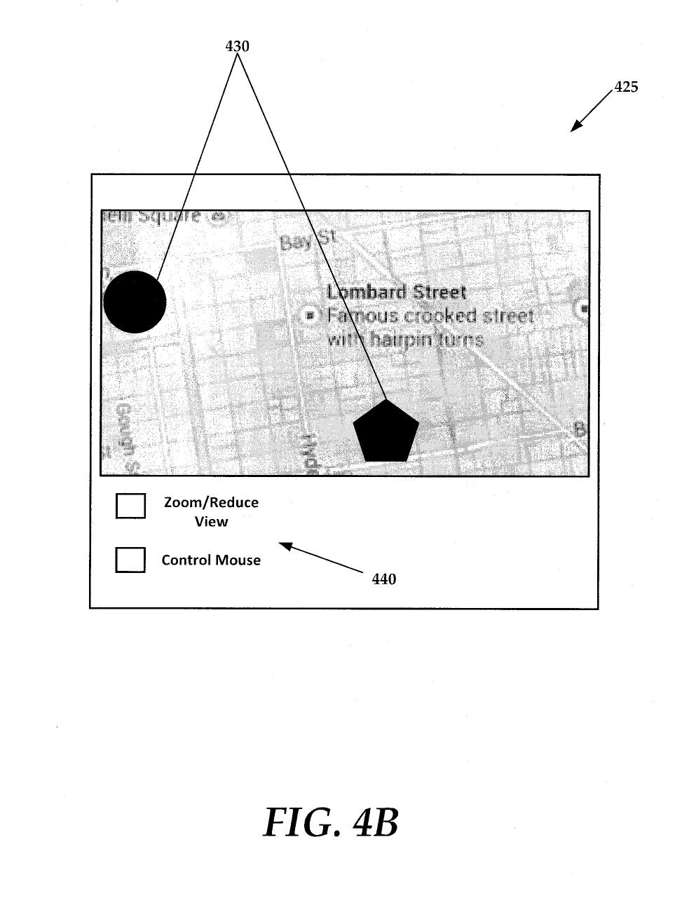

As mentioned above, the limited functionality map may comprise a resized version or enlarged portion of the full functionality map (see FIG. 4B).

When the user viewing the second view that is an enlarged portion or a section of the full functionality map, the view sharing application 105A of the first computing system 110 is configured to place a boundary line on the first view that represents the resized version or enlarged portion of the full functionality map. For example, the full sized map displayed in the first view is augmented with a window box (see FIG. 4A) that allows the travel agent to appreciate what portion of the map is being viewed by the traveler in the second view.

In accordance with the present technology, during a view sharing session, a user of the first computing system 110 can prevent the user of the second computing system 115 from using the limited functionality map when the user of the first computing system 110 is not present. For example, if the travel agent steps away from their first computing system 110, the travel agent can prevent the traveler from further viewing or use of the map.

In other embodiments, the traveler can use a travel application or map when the travel agent is not present or after termination of the view sharing session. The view extension module 160 of the view sharing application 105A of the first computing system 110 can provide the second computing system 115 with a token that can be used by the user of the second computing system 115 to continue the view sharing session after the user of the first computing system 115 has left the view sharing session. The second computing system 115 can provide the token to the view extension module 160 of the view sharing application 105A of the first computing system 110 to continue the view sharing session at a later point in time. In one embodiment, the user of the first computing system 110 can be re-invited by the view extension module 160 of the view sharing application 105A of the second computing system 115 to the view sharing session if the token is used to continue a previous view sharing session. For example, the traveler can use the token at a later time to select a hotel after the traveler has had an opportunity to think about what hotel they prefer.

In some embodiments, the view sharing application 105A of the second computing system 115 can deny the traveler access to the map if the travel agent is currently unavailable. The view sharing application 105A of the second computing system 115 to can also allow the traveler to access the map and browse various areas of interest, with or without the travel agent present. In another embodiment, the view sharing application 105A of the second computing system 115 allows the traveler to access a map and browse areas of interest and select a preferred hotel(s), which in turn, causes an email to be sent to the travel agent with the selections. The travel agent can then book the reservation.

In another example, the traveler can be given permission to reserve a hotel of their choice, while a commission for the reservation is credited to the travel agent. The view sharing application 105A of the second computing system 115 can transmit this credit or notification using the notification module 150.

Thus, in some instances, the view sharing module 155 of the view sharing application 105A of the second computing system 115 is configured to keep information for a view sharing session available for a specified period of time (time to live [TTL]). In one embodiment, the period of time is a week, although other time periods are possible and depend upon the needs of the end users.

According to some embodiments, the view sharing module 155 of the view sharing application 105A of the first computing system 110 is configured to receive selections of points of interest from the user of the second computing system 115. For example, the traveler can select one of the hotels that is displayed on the map. When the selection is made, the view sharing application 105A can cause the notification module 150 to notify the user of the first computing system 110 of the selection(s).

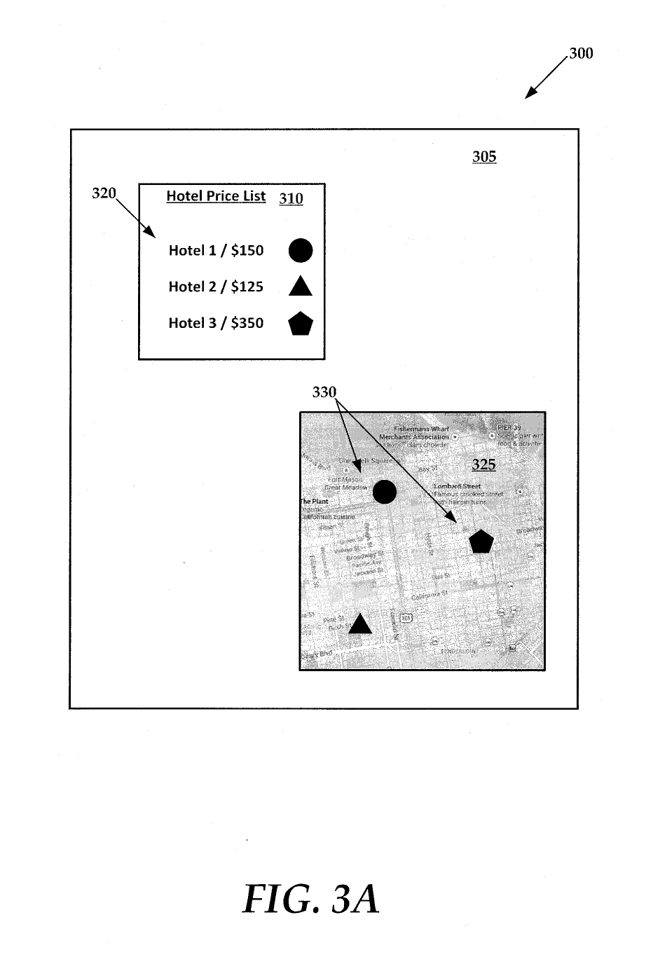

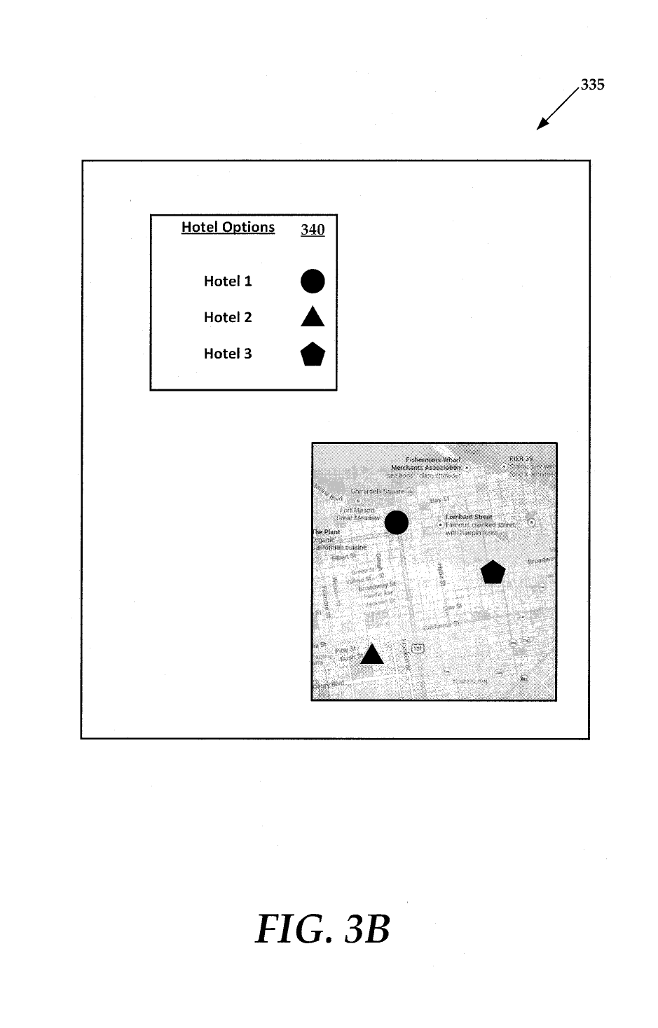

Referring now to FIGS. 3A and 3B, illustrate a dual permission view sharing session. FIG. 3A is a first view 300 of a data representation 305 (e.g., underlying application). The data representation 300 comprises a hotel price list 310 that comprises a plurality of hotel selections 320 that have been selected using a user profile, corporate requirements, or other limitations. Of note, the hotel price list 310 includes prices for each of the selected hotels. The data representation further includes a map 325 that includes a plurality of POIs 330 that include the plurality of hotel selections 320, which have been plotted onto the map 325.

This first view 300 is evaluated by the view sharing application 105A of the second computing system 115 and converted into a second view 335 that is illustrated in FIG. 3B. The view sharing application 105A will further use the user profile, corporate requirements, or other limitations to create the second view 335. The second view 335 includes a similar view to the first view, except that the hotel price list 310 of FIG. 3A is converted into a hotel options list 340. The view sharing application 105A can create the hotel options list 340 by not displaying price data that was included in the hotel price list 310 of FIG. 3A. Thus, the second view 335 includes an altered version of the content of the first view.

In other instances, rather than obscuring content, the view sharing application 105A can edit or modify the content of the first view to create the second view. FIGS. 4A and 4B collectively illustrate a content modification process. A first view 400 of a data representation 405 is illustrated in FIG. 4A. The data representation 405 comprises a map application that includes various controls 410 that control a map 415. In this example, the controls 410 includes a zoom control, a center view control, select POIs, display POI information, select view type, control mouse, and toggle text. These are all filters that are selectable by the user of the first computing system 110. Selection of one or more of these controls makes the selected controls available to the user of the second computing system 115. The map 415 is viewable by a travel agent and the map 415 includes a plurality of POIs 420 that represents hotels that are available for the traveler.

FIG. 4B is a second view 425 that is a resized (e.g., optimized) view of the map 415 of the first view 400. The second view 425 includes a subset 430 of the plurality of POIs 420 that were displayed in the first view 400. The second view 425 also includes a subset 440 of controls that includes the zoom feature and control mouse feature. These were features that were selected by the travel agent from the first view 400.

As the traveler moves around the map and resizes the map, a boundary line 435 is drawn on the first view 400. As the size and position of map changes on the second view 425, the boundary line 435 will change and move on the first view 400 correspondingly.

While the above descriptions contemplate a view sharing session involving a hotel reservation application with mapping functions that are shared between a travel agent and traveler, it will be understood that the view sharing session can be used for other purposes such as real estate sales, product design, or other commercial or retail purposes. The present technology can be used in any situation where a user desires to share a view of a data representation with a second user, but that the user wants to obscure, redact, edit, modify, change, add to, or otherwise alter the information that is viewable by the second user.

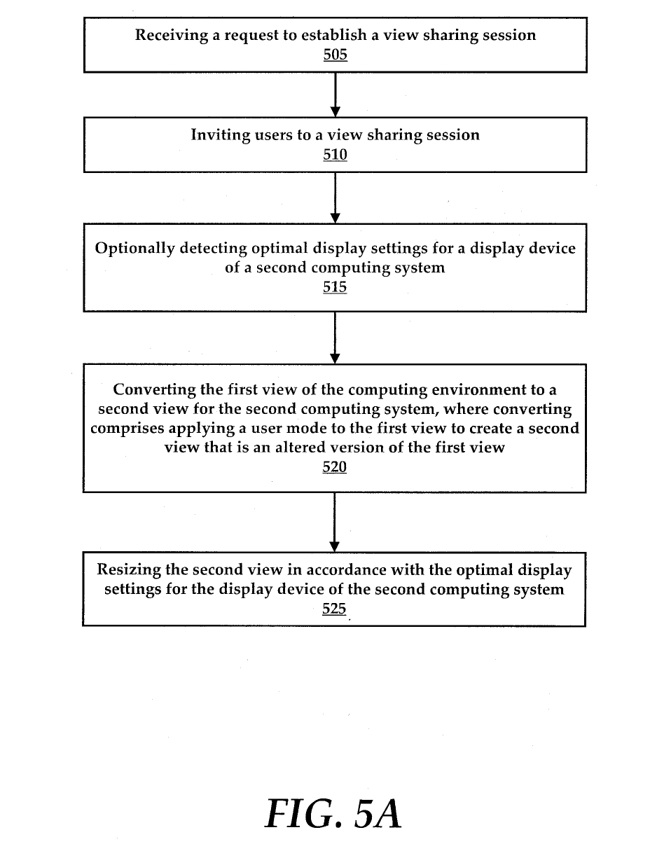

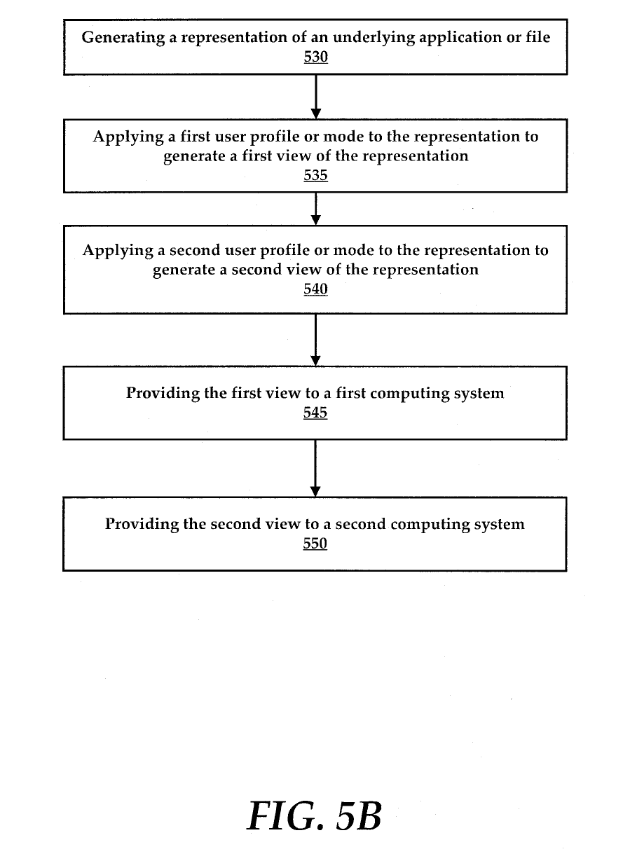

FIG. 5A is a flowchart of an example method for dual permission view sharing. The method comprises receiving 505 a request to establish a view sharing session and inviting 510 users to a view sharing session. The invitation can include an email with a link to the view sharing session.

Next, the method comprises optionally detecting 515 optimal display settings for a display device of a second computing system. The method also includes initiating the view sharing session by receiving a first view of a data representation generated by a first computing system. As mentioned above, the first view represents content that is currently being displayed on a display device of the first computing system.

Initiating the view sharing session further includes converting 520 the first view of the data representation to a second view for the second computing system, where converting comprises applying a user mode to the first view to create a second view that includes at least a part of the first view. The second view is an altered version of the first view. The method also includes resizing 525 the second view in accordance with the optimal display settings for the display device of the second computing system.

FIG. 5B is an example method for sharing a view or representation of an application or a file between two or more computing systems. The method is executed by a computing device, such as the server 105 of FIG. 1. In one embodiment, the method comprises generating 530 a representation of an underlying application or file. For example, the server can execute a map application or generate a view of an image or model.

Next, the method includes sharing the representation by first applying 535 a first user profile or mode to the representation to generate a first view of the representation. For example, the first profile for a travel agent is applied to a view of a travel agent reservation application that is executed by the server.

Next, the method includes applying 540 a second user profile or mode to the representation to generate a second view of the representation. The second view is different from the first view. For example, the second user is a traveler and the second view is generated for the traveler. The second view is an altered version of the representation of the travel agent reservation application that is executing on the server. The second view may include only a portion of the contents that are shown to the travel agent in the first view.

Next, the method comprises the server providing 545 the first view to a first computing system and providing 550 the second view to a second computing system.

Additional or fewer steps that those described in the flow charts are also contemplated for use in accordance with the present disclosure.

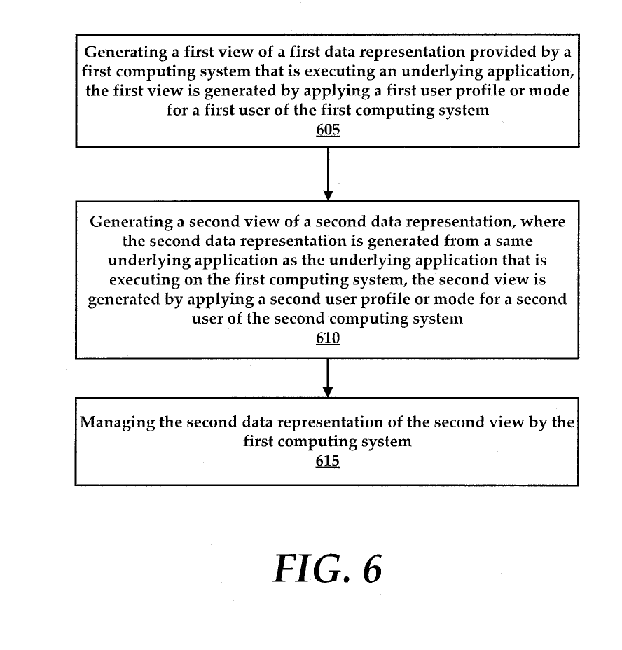

Referring now to FIG. 6, a flowchart of a method of cooperative browsing is illustrated. In general, the method is cooperatively executed by two end user computing systems. In some embodiments, the first computing system executes an underlying application, such as a travel agent reservation application, a map application, a three dimensional modeling application, a word processing application, or other similar applications.

The second computing system also executes the same underlying application as the underlying application that executes on the first computing device. Each of the first and second computing systems also store and execute a view sharing application. The view sharing applications cooperate with the underlying application such that one of the end users (or both) can control or manage what is seen by the other end user(s).

For example, if the first user is a travel agent and the second user is a traveler, the travel agent can control what is being seen by the traveler, even though the same underlying application is being executed on the traveler's computer as the underlying application that is being used by the travel agent.

Each user is provided with a view of a data representation that generated by their underlying application. The view can be altered by the view sharing application applying a user profile or mode to the data representation. Thus, the travel agent is provided with a first view and the traveler is provided with a second view.

In some instances the user profile or mode for each user is unique and applies filtering parameters, permissions, or other alterations to the data representation. For example, the view sharing application can apply a first user profile or mode to a first data representation generated by the travel agent reservation application that allows the underlying application to create a first data representation that is appropriate for the travel agent. In one instance, the first data representation will include certain proprietary content that is available only to a travel agent.

The view sharing application executing on the second computing device can apply a second user profile or mode to a second data representation generated by the travel agent reservation application (e.g., underlying application) that allows the underlying application to create a second data representation that is appropriate for the traveler. In one instance, the second data representation will include certain proprietary content that is available only to a traveler.

In one embodiment, the travel agent can manage the content of the second data representation that is being displayed to the traveler by using the view sharing application that executes on the first computing device.

The method comprises generating 605 a first view of a first data representation provided by a first computing system that is executing an underlying application. As mentioned above, the first data representation is displayed on a display device of the first computing system. Furthermore, the first view is generated by applying a first user profile or mode for a first user of the first computing system.

Next, the method comprises generating 610 a second view of a second data representation. The second data representation is generated from a same underlying application as the underlying application that is executing on the first computing system. The same underlying application is executed on a second computing device. Additionally, the second data representation is displayed on a display device of the second computing system.

In some embodiments, the second view is generated by applying a second user profile or mode for a second user of the second computing system.

This process of generating and displaying the first and second views is referred to as a cooperative browsing session. This process occurs simultaneously as both users are using the underlying application. The view sharing applications on the respective computer systems will apply the user profiles or modes to create the views.

In some embodiments, the method includes determining synchronization points for both the first and second views. The synchronization points define what parts of the first and second data representations are included in the first and second views as a baseline amount of content. The synchronization points are the same in both the first and second views. For example a travel agent application can include synchronization points such as a hotel map and a hotel price list. Both the first view and the second view will include these synchronization points. The content of these synchronization points can be altered by application of the user profiles or modes. For example, the travel agent mode is applied such that the synchronization points are tailored for the travel agent. Likewise, the traveler mode is applied such that the synchronization points are tailored for the traveler.

The method can also include synchronizing the synchronization points for both the first and second views. It will be understood that the steps of determining synchronization points and synchronizing the synchronization points are processes within the steps of generating the first and second view.

Also, the method comprises an optional step of managing 615 the second data representation of the second view by the first computing system. Alternatively, the first data representation can be managed by the second computing system in a similar manner. In one example, the first user can manage what controls are available to the second user. In another example, the first user can determine what type of content should be available to the second user. The first user can apply additional constraints other than what is included in the user profile or mode for the second user.

Again, the view sharing application can alter the view of a user by removing content, adding additional content, changing the size of a view or data representation, zooming a data representation, or otherwise modifying the data representation using optimal display characteristics for the computing system. For example, the view sharing application may apply a native resolution to create a view.

In another use case, the first (host) and second (guest) computer systems are executing a map application. The view sharing applications of the respective computer systems will control what is seen by each of the end users.

In one example, the view sharing application of the second computing system can force coordinates of the map being viewed by the second computing system to a center point on a map. The view sharing application of the second computing system can also set a zoom level to be synchronized with the zoom level of the first computing system.

It will be assumed that both users are viewing the same map (e.g., data representation). If the second user of the second computing system changes their browser window size, the view sharing application can ensure that an optimal resolution is maintained for the display device used by the second computing system.

This method is in sharp contrast to a screen sharing application that will simply squeeze an entire host screen (e.g., first view) into a window size of the guest, which reduces quality and legibility.

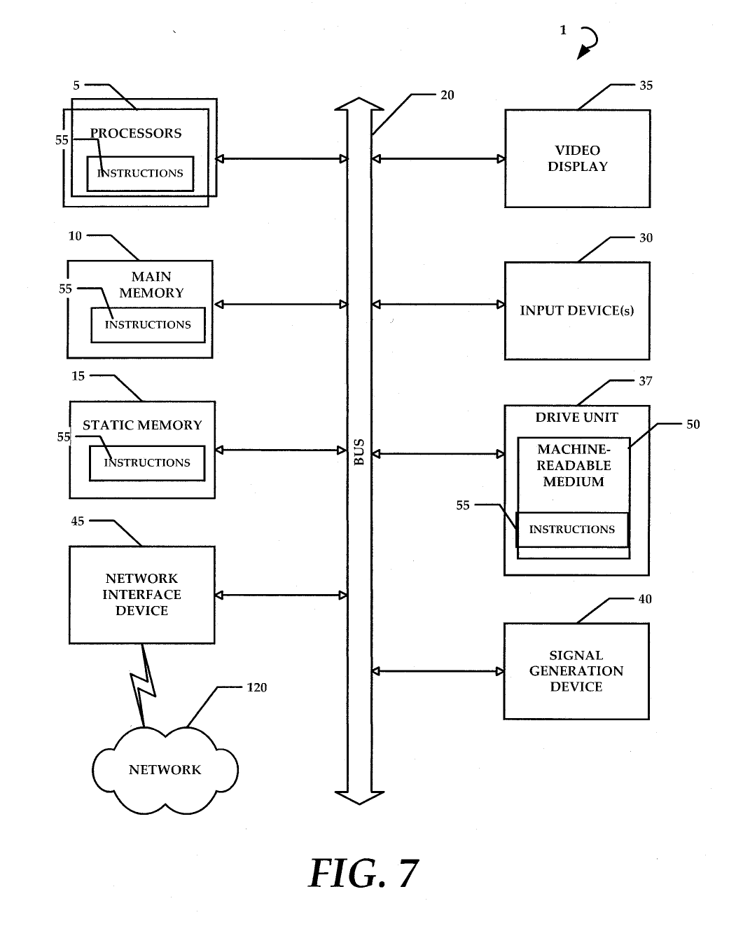

FIG. 7 is a diagrammatic representation of an example machine in the form of a computing system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computing system 1 includes a processor or multiple processors 5 (e.g., a central processing unit (CPU), a graphics processing unit (GPU), or both), and a main memory 10 and static memory 15, which communicate with each other via a bus 20. The computing system 1 may further include a video display 35 (e.g., a liquid crystal display (LCD)). The computing system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computing system 1 may further include a data encryption module (not shown) to encrypt data.

The disk drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processors 5 during execution thereof by the computing system 1. The main memory 10 and the processors 5 may also constitute machine-readable media.

The instructions 55 may further be transmitted or received over a network 140 (see FIG. 2) via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing systems that are coupled to the Internet service, and that the computing systems may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

1. A method executed by a computing system, the computing system comprising a processor and memory for storing executable instructions, the processor executing the instructions to perform the method, the method comprising:
receiving a first view of a data representation generated by a first computing system, the first view representing content that is currently being displayed on a display device of the first computing system;
sharing the first view of the data representation with a second computing system; and
applying a user mode to the first view to create a second view that includes at least a part of the first view, the second view being an altered version of the first view.

2. The method according to claim 1, further comprising receiving selections from a user of the first computing system that defines how the first view is altered to create the second view.

3. The method according to claim 1, wherein applying a user mode to the first view comprises resizing at least a part of the first view.

4. The method according to claim 3, wherein resizing comprises resizing at least a part of the first view in such a way that the at least a part of the first view is optimally displayed on a display device of the second computing system.

5. The method according to claim 4, further comprising marking the first view with a boundary line that is the shape and size of the second view that is displayed on the display device of the second computing system.

6. The method according to claim 1, wherein the data representation generated by the first computing system includes an application with controls, wherein a user of the second computing system can control the application with the controls using the second computing system.

7. The method according to claim 6, wherein part of the controls are accessible to a user of the first computing system but are inaccessible to the user of the second computing system.

8. The method according to claim 7, further comprising receiving selections from the user of the first computing system as to which of the controls is accessible to the user of the second computing system.

9. The method according to claim 1, wherein content that is currently being displayed on the display device of the first computing system is selected according to a user profile for a user of the second computing system, corporate policies, and permissions for the user of the second computing system.

10. The method according to claim 1, wherein the first view is a full functionality map, wherein the second view is a different functionality map.

11. The method according to claim 10, wherein the different functionality map comprises a set of points of interest (POIs) that have been filtered using at least one of: a user profile for a user of the second computing system, corporate policies, and permissions for the user of the second computing system, or combinations thereof.

12. The method according to claim 11, wherein the full functionality map comprises selectable filter criteria for the user of the first computing system.

13. The method according to claim 11, wherein the different functionality map comprises a resized version or enlarged portion of the full functionality map.

14. The method according to claim 13, wherein the full functionality map includes a boundary line that represents the resized version or enlarged portion of the full functionality map.

15. The method according to claim 13, wherein during sharing, a user of the first computing system can prevent the user of the second computing system from using the different functionality map when the user of the first computing system is not present.

16. The method according to claim 13, further comprising receiving selections of points of interest from the user of the second computing system; and notifying the user of the first computing system of the selections.

17. A method of a cooperative browsing session, comprising:
generating a first view of a first data representation provided by a first computing system that is executing an underlying application, the first data representation being displayed on a display device of the first computing system, the first view being generated by applying a first user profile or mode for a first user of the first computing system;
generating a second view of a second data representation, the second data representation being generated from a same underlying application as the underlying application that is executing on the first computing system, the same underlying application being executed on a second computing device, the second data representation being displayed on a display device of the second computing system, the second view being generated by applying a second user profile or mode for a second user of the second computing system; and
managing the second data representation of the second view by the first computing device.

18. The method according to claim 17, wherein applying the second user mode to the first view comprises resizing at least a part of the second data representation

19. The method according to claim 18, wherein resizing comprises resizing at least a part of the first view in such a way that the at least a part of the first view is optimally displayed on a display device of the second computing system.

20. The method according to claim 18, further comprising marking the first view with a boundary line that is the shape and size of the second view that is displayed on the display device of the second computing system.

21. The method according to claim 17, further comprising generating a token for the cooperative browsing session, wherein the token is provided to the second computing system.

22. The method according to claim 21, wherein the first data representation generated by the first computing system includes controls for the underlying application, wherein a user of the second computing system can control the same underlying application executing on the second computing device with the controls using the second computing system.

23. The method according to claim 19, further comprising:
receiving the token from the second computing system;
initiating a second browsing session subsequent to the cooperative browsing session in response to receiving the token, wherein the second browsing session reinitiates the cooperative browsing session.

24. The method according to claim 17, further comprising determining synchronization points for the first and second data representations, wherein the first and second views each include the synchronization points.

25. A method executed by a computing system, the computing system comprising a processor and memory for storing executable instructions, the processor executing the instructions to perform the method, the method comprising:
generating a data representation of an underlying application or file;
sharing the data representation by:
applying a first user profile or mode to the data representation to generate a first view of the data representation; and
applying a second user profile or mode to the data representation to generate a second view of the data representation, the second view being different from the first view;
providing the first view to a first computing system; and
providing the second view to a second computing system.
